(19) United States
(12) Patent Application Publication
(10) Pub. No.: US 2025/0265960 A1
(43) Pub. Date: Aug. 21, 2025

(54) DISPLAY PIXEL COMPRISING LIGHT-EMITTING SOURCES

(71) Applicant: Aledia, Echirolles (FR)

(72) Inventors: Jaehoon Lee, Grenoble (FR); Frédéric Mercier, Coublevie (FR); Ivan Petkov, Saint Martin D'Heres (FR)

(73) Assignee: Aledia, Echirolles (FR)

(21) Appl. No.: 18/878,550

(22) PCT Filed: Jun. 27, 2023
(86) PCT No.: PCT/EP2023/067507

§ 371 Date: Dec. 23, 2024

(30) Foreign Application Priority Data
Jun. 29, 2022 (FR) FR2206560

(51) Int. Cl. G09G 3/20; G09G 3/32

(52) U.S. Cl. CPC G09G 3/2014; G09G 3/32; G09G 2300/0814; G09G 2300/0857; G09G 2310/08

(57) ABSTRACT

A display pixel including at least one light-emitting source and an electronic circuit including a storage circuit for storing at least one digital signal and a driver circuit for driving said light-emitting source based on stored digital signal, said display pixel including at least a first conductive pad intended to receive a first binary signal and a second conductive pad intended to receive a second binary signal, the first and second electrically conductive pads being connected to said electronic circuit. Said electronic circuit is configured to update said stored digital signal from the second binary signal after the detection of a first pattern of the first binary signal simultaneously with a second pattern of the second binary signal.

This application is a translation of and claims the priority benefit of French patent application number 22/06560, filed on 29 Jun. 2022, entitled “Display pixel comprising light-emitting sources”, which is hereby incorporated by reference to the maximum extent allowable by law.

### TECHNICAL FIELD

The present disclosure concerns a display pixel comprising light-emitting sources, for example light-emitting diodes, and a display screen having such display pixels.

### BACKGROUND ART

A pixel of an image corresponds to the unit element of the image displayed by a display screen. For the display of color images, the display screen generally comprises, for the display of each pixel of the image, at least three components, also called display sub-pixels, which each emit a light radiation, called image pixel color component substantially in a single color (for example, red, green, and blue). The superposition of the image pixel color components emitted by the three display sub-pixels provides the observer with the colored sensation corresponding to the pixel of the displayed image. In this case, the assembly formed by the three display sub-pixels used for the display of a pixel of an image is called display pixel of the display screen. Each display sub-pixel may comprise a light source, particularly a light-emitting diode.

The display pixels may be distributed in an array, each display pixel being located at the intersection of a row (also called line) and of a column of the array. Electrodes are provided along the rows and the columns to connect each display pixels to control circuits. Generally, each row of display pixels is successively selected by signal transmitted along the row electrodes, and the display pixels of the selected row are programmed to display the desired image pixels by signals transmitted along the column electrodes.

An active array is a screen drive architecture enabling to maintain all the pixel rows active for the entire duration of an image, conversely to arrays said to be passive, where each row is only active for a time T=Tframe/M (where Tframe is the duration of the display of the whole image and M is the number of lines of the screen). This enables to increase the luminosity of the display screen. Further, it is possible to send low voltage or current levels on the array control lines, which enables to display bigger data flows.

The propagation time of a signal between the display pixel and the control circuits varies with respect to the position of the display pixel on the display screen. It is necessary to take into account of these different propagation times to make sure that all the display pixels of a row are correctly selected and all the data are correctly transmitted to the selected display pixels. This can result in an upper limit as regards the resolution and/or the operation speed of the display screen.

Moreover, for some applications, only a part of the image displayed on the display screen needs to be updated. However, known display screens may only allow the update of whole rows of display pixels.

### SUMMARY OF INVENTION

An object of an embodiment is to provide a display pixel comprising light-emitting sources and a display screen comprising such display pixels overcoming all or part of the disadvantages of existing display pixels comprising light-emitting sources and display screens comprising such display pixels.

Another object of an embodiment is to increase the resolution and/or the operation speed of the display screen for display screen having important propagation time variations on the row/column electrodes with respect to the position of the display pixels on the display screen.

Another object of an embodiment is to allow partial update of the displayed image.

Another object of an embodiment is to provide a solution for individually controlling and changing the operating mode of a display pixel.

One embodiment provides a display pixel comprising at least one light-emitting source and an electronic circuit comprising a storage circuit for storing at least one digital signal and a driver circuit for driving said light-emitting source based on the stored digital signal, said display pixel comprising at least a first electrically conductive pad intended to receive a first binary signal and a second electrically conductive pad intended to receive a second binary signal, the first and second electrically conductive pads being connected to said electronic circuit, said electronic circuit being configured to update said stored digital signal from the second binary signal after the detection of a first pattern of the first binary signal simultaneously with a second pattern of the second binary signal.

The selection of a display pixel for the updating of the digital signal in the storage circuit is obtained by using both first and second signals. This allows advantageously to select a display pixel with a simple protocol. According to an embodiment, said electronic circuit is configured not to update said stored digital signal from the second binary signal when the first pattern of the first binary signal is not detected simultaneously with the second pattern of the second binary signal. For a display screen having an array of display pixels, this allows advantageously to select only some display pixels of a row of a display screen instead of selecting all the display pixels of the row.

According to an embodiment, said electronic circuit is configured to end the update of said stored digital signal from the second binary signal after the detection of a third pattern of the first binary signal simultaneously with a fourth pattern of the second binary signal. According to an embodiment, the third pattern is identical to the first pattern and the fourth pattern is different from the second pattern. According to an embodiment, the fourth pattern is the logical complement of the second pattern. This allows an important flexibility when conceiving the waveforms of the first and second binary signals.

According to an embodiment, the first pattern corresponds to the first binary signal remaining at a given logical state. According to an embodiment, the second pattern corresponds to the second binary signal comprising one rising edge, or two successive rising edges, or one falling edge, or two successive falling edges, or one rising edge followed by one falling edge, or one falling edge followed by one rising edge. This allows advantageously to drive a heavy load display panel with low-speed operation.

According to an embodiment, after the detection of the first pattern of the first binary signal simultaneously with the second pattern of the second binary signal, the electronic circuit is configured to update the digital signal in the storage circuit clocked by a clock signal equal to the first binary signal. This allows advantageously to use the first binary signal to clock the update of the digital signal in the storage circuit since only selected the display pixel performs an update operation.

According to an embodiment, the electronic circuit is configured to update successive bits of the digital signal in the storage circuit equal to the successive logical states of the second binary signal at only the rising edges, or at only the falling edges, or at the rising and falling edges of the clock signal. This allows advantageously to implement different speed operation.

According to an embodiment, the driver circuit is configured to drive said light-emitting source by pulse-width modulation based of the digital signal and pulses of the first binary signal.

According to an embodiment, said electronic circuit is configured to perform the update of said stored digital signal without needing the simultaneous reception of the first and second patterns and without needing the simultaneous reception of the third and fourth patterns and said driver circuit is configured to perform the driving of said light-emitting source without needing the simultaneous reception of the first and second patterns and without needing the simultaneous reception of the third and fourth patterns.

According to an embodiment, the driver circuit comprises a finite-state machine comprising at least three states, the first state corresponding to the update of said digital signal, the second state corresponding to the driving of said light-emitting source, and the third state corresponding to the switching off of said light-emitting source without update of the digital signal. This allows advantageously the update the digital signal in the storage circuit of a selected display pixel without disturbing the operation of another non-selected pixel of the same row.

According to an embodiment, the transition of the finite-state machine from the second state to the first state corresponds to the detection by said electronic circuit of the first pattern of the first signal simultaneously with the second pattern of the second signal.

According to an embodiment, the transition of the finite-state machine from the first state to the second state corresponds to the detection by said electronic circuit of the third pattern of the first signal simultaneously with the fourth pattern of the second signal. The end of the selection of a display pixel for the updating of the digital signal in the storage circuit is also obtained by using both first and second signals.

According to an embodiment, the transition of the finite-state machine from the second state to the third state corresponds to the detection by said electronic circuit of the third pattern of the first signal simultaneously with the fourth pattern of the second signal.

According to an embodiment, the transition of the finite-state machine from the third state to the second state corresponds to the detection by said electronic circuit of the third pattern of the first signal simultaneously with the fourth pattern of the second signal.

One embodiment provides a display screen comprising:
display pixels as previously defined arranged in rows and in columns;
first electrically conductive tracks extending along the rows and connected to the electronic circuits of the display pixels;
a timing circuit for supplying the first signal comprising the first pattern successively on each first electrically conductive track;
second electrically conductive tracks extending along the columns and connected to the electronic circuits of the display pixels;
a data delivery circuit for supplying the second signals on the second electrically conductive tracks, at least some of the second signals comprising each the second pattern, so that each display pixel receiving simultaneously the first and second patterns performs an update of said stored digital signal.

According to an embodiment, the circuit for supplying the first signal and the circuit for supplying the second signals are configured, after the supply of the first pattern on one of said first electrically conductive tracks, not to supply simultaneously the first pattern on said first electrically conductive track and the second pattern on the second electrically conductive tracks during the update performed by the display pixels connected to said first electrically conductive track.

### BRIEF DESCRIPTION OF DRAWINGS

The foregoing features and advantages, as well as others, will be described in detail in the following description of specific embodiments given by way of illustration and not limitation with reference to the accompanying drawings, in which:

FIG. 1 partially and schematically shows an example of a display screen;

FIG. 2 shows an example of a partially modified image;

FIG. 3 shows a block diagram of an embodiment of a display pixel of the display screen of FIG. 1;

FIG. 4 shows a timing diagram of signals sent to a display pixel according to an embodiment of a method for selecting the display pixel;

FIG. 5, FIG. 6, FIG. 7, FIG. 8, FIG. 9, and FIG. 10 show more precise timing diagrams of signals sent to a display pixel according to embodiments of a method for selecting the display pixel;

FIG. 11 illustrates different zones of a partially updated image displayed on a display screen;

FIG. 12 shows a timing diagram of signals supplied to display pixels according to the embodiment of the method for selecting display pixels illustrated from FIG. 4 to FIG. 10;

FIG. 13 is a state diagram of an embodiment of a finite-state machine of a display pixel;

FIG. 14 illustrates events triggering transitions in the state diagram of FIG. 13 according to an embodiment;

FIG. 15, FIG. 16, and FIG. 17 show timing diagrams of signals provided to display pixels, for a partially updated image, according to the embodiment with the state diagram of FIG. 13 and the events shown in FIG. 14;

FIG. 18 illustrates events triggering transitions in the state diagram of FIG. 13 according to another embodiment;

FIG. 19, FIG. 20, and FIG. 21 show timing diagrams of signals provided to display pixels, for a partially updated image, according to the embodiment with the state diagram of FIG. 13 and the events shown in FIG. 18;

FIG. 22 shows a partially displayed image when a known method for selecting display pixels is implemented;

FIG. 23 shows a partially displayed image when an embodiment of the method for selecting display pixels is implemented;

FIG. 24 is a very simplified cross-section view of a display pixel; and

FIG. 25 is a bottom view of the display pixel of FIG. 24.

### DESCRIPTION OF EMBODIMENTS

Like features have been designated by like references in the various figures. In particular, the structural and/or functional features that are common among the various embodiments may have the same references and may dispose identical structural, dimensional and material properties. For the sake of clarity, only the steps and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements. Further, a signal which alternates between a first constant state, for example, a low state, noted “0”, and a second constant state, for example, a high state, noted “1”, is called a “binary signal”. The high and low states of different binary signals of a same electronic circuit may be different. In practice, the binary signals may correspond to voltages or to currents which may not be perfectly constant in the high or low state. Further, in the following description, the source and the drain of a MOS transistor are called “power terminals” of the insulated gate field-effect transistor, or MOS transistor.

Further, unless indicated otherwise, when it is spoken of a voltage at a conductive pad, the difference between the potential at said conductive pad and a reference potential, for example, the ground, taken as equal to 0 V, is considered.

Unless specified otherwise, the expressions “around”, “approximately”, “substantially” and “in the order of” signify within 10%, and preferably within 5%. Further the expression “substantially constant” means which varies by less than 10% over time with respect to a reference value.

In the following specification, embodiments are disclosed for display pixels comprising light-emitting diodes. However, these embodiments can be implemented for display pixels comprising electroluminescent sources different from light-emitting diodes, for example organic light-emitting diodes, field-induced polymer electroluminescent components, laser diodes.

In the following specification, embodiments are disclosed for a color display screen comprising color display pixels, each display pixel comprising light-emitting diodes adapted to emit radiations of different colors. However, these embodiments also apply for a monochromatic display screen comprising monochromatic display pixels, each monochromatic display pixel comprising one light-emitting diode or only light-emitting diodes adapted to emit a radiation of a single color.

FIG. 1 partially and schematically shows an example of a display screen 10. Display screen 10 comprises display pixels 12_{i,j}, for example, arranged in M rows and in N columns, M being an integer varying from 1 to 8,000 and N being an integer varying from 1 to 16,000, i being an integer varying from 1 to M, and j being an integer varying from 1 to N. As an example, in FIG. 1, M and N are equal to 6. Each display pixel 12_{i,j} is coupled to a source of a low reference potential Gnd, for example, the ground, via an electrode 14ᵢ and to a source of a high reference potential Vcc via an electrode 16ⱼ. As an example, electrodes 14ᵢ are shown as being aligned along the rows in FIG. 1 and electrodes 163 are shown as being aligned along the columns in FIG. 1, the reverse layout being possible. The power supply voltage of the display screen corresponds to the voltage between high reference potential Vcc and low reference potential Gnd. The power supply voltage particularly depends on the arrangement of the light-emitting diodes and on the technology according to which the light-emitting diodes are manufactured. As an example, the power supply voltage may be in the order of from 4 V to 5 V.

For each row, the display pixels 12_{i,j} in the row are coupled to at least one row electrode 18ᵢ. For each column, the display pixels 12_{i,j} in the column are coupled to at least one column electrode 20ⱼ. Display screen 10 comprises a timing circuit 22 coupled to row electrodes 18ᵢ and adapted to delivering a timing signal Comᵢ on each row electrode 18ᵢ. Display screen 10 comprises a data delivery circuit 24 coupled to column electrodes 20ⱼ and adapted to delivering a data signal Dataⱼ on each column electrode 20. Timing circuit 22 and data delivery circuit 24 are controlled by a circuit 26, for example comprising a microprocessor.

Generally, each row of display pixels is successively selected, and the display pixels of the selected row are programmed to display the desired image pixels. In a known method for selecting display pixels, timing circuit 22 is adapted to delivering timing signals Comᵢ on row electrodes 18ᵢ to successively select each row of display pixels 12_{i,j} and data delivery circuit 24 is adapted to delivering data signals Dataⱼ on each column electrode 20ⱼ representative of color digital data that are stored in the selected display pixels 12_{i,j}.

The propagation time of a signal between display pixel 12_{i,j} and timing circuit 22 or data delivery circuit 24 varies with respect to the position of display pixel 12_{i,j} on display screen 10. In the arrangement shown in FIG. 1, the propagation time on row electrodes 18ᵢ is the shortest for the display pixels 12_{i,j} on the first column that is the closest to timing circuit 22 and is the longest for the display pixels 12_{i,j} on the last column that is the furthest from timing circuit 22. The propagation time on column electrodes 20ⱼ is the shortest for the display pixels 12_{i,j} on the first row that is the closest to data delivery circuit 24 and is the longest for the display pixels 12_{i,j} on the last row that is the furthest from data delivery circuit 24. It is necessary to take into account of these different propagation times to make sure that, for each row, all the display pixels of the row are correctly selected and all the data are correctly transmitted to the selected display pixels. This can result in an upper limit as regards the resolution and/or the operation speed of the display screen.

For some applications, only a part of the image displayed on the display screen needs to be updated.

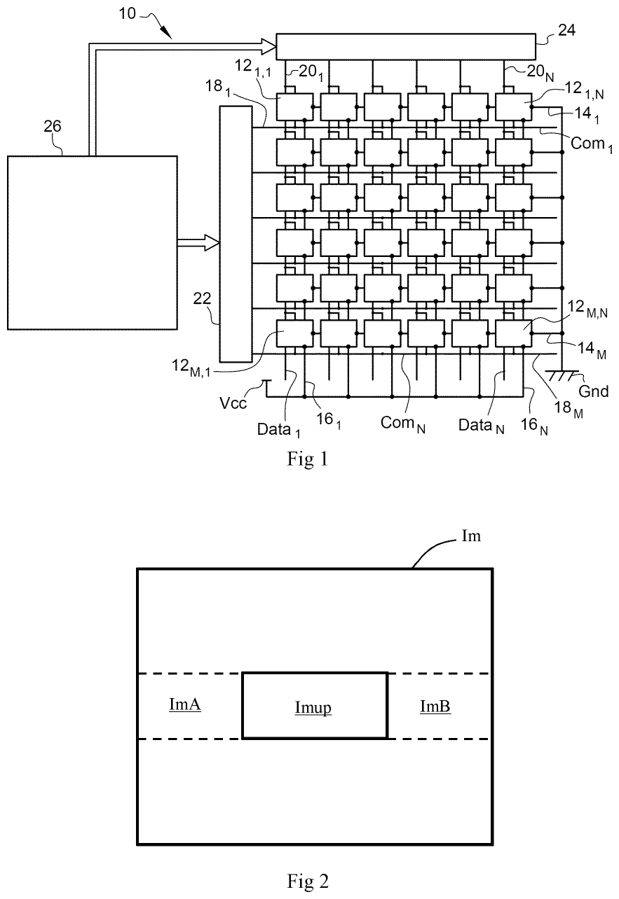

FIG. 2 shows schematically an image Im displayed on a display screen for which only a portion Imup needs to be updated, the rest of image Im remaining unchanged. For a known display screen, the rows of the display screen that include portion Imup to update need to be successively selected. Therefore, all the display pixels of each successively selected row need to receive data of the image to be displayed. This means that even the display pixels displaying portions ImA and ImB of image Im are selected and need to receive data of the next image to be displayed even though portions ImA and ImB remain unchanged.

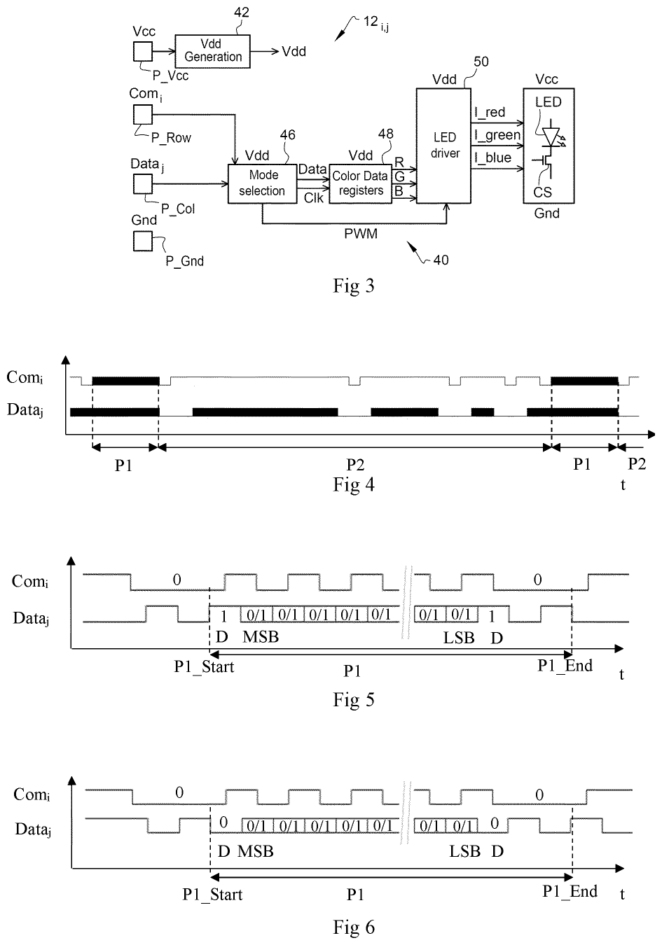

FIG. 3 shows a block diagram of an embodiment of a display pixel 12_{i,j} of display screen 10. For a color display screen, display pixel 12_{i,j} comprises at least three light-emitting diodes emitting radiations of different colors, a single light-emitting diode LED being shown in FIG. 3. Each light-emitting diode LED is series-coupled to a controllable current source CS, for example comprising a MOS transistor. In the present example, for each light-emitting diode LED, the anode of light-emitting diode LED receives high reference potential Vcc, received at a conductive pad P_Vcc of the display pixel 12_{i,j}, and the cathode of light-emitting diode LED is for example coupled to a terminal of controllable current source CS, the other terminal of controllable current source CS receiving low reference potential Gnd, received at a conductive pad P_Gnd of the display pixel 12_{i,j}. As a variation, the cathode of light-emitting diode LED receives low reference potential Gnd and the anode of light-emitting diode LED is coupled to a terminal of controllable current source CS, the other terminal of controllable current source CS receiving high reference potential Vcc.

Display pixel 12_{i,j} further comprises a circuit 40 for driving controllable current source CS. Driver circuit 40 may particularly comprise electronic components such as MOS transistors. It may be desirable to use a decreased power supply voltage, smaller than 4 V, for example in the order of 1 V or of 1.8 V, to power the electronic components of driver circuit 40, this decreased power supply voltage for example corresponding to the voltage likely to be applied between the power terminals of the MOS transistors. For this purpose, display pixel 12_{i,j} may comprise a circuit 42 (Vdd Generation) for delivering, from power supply voltage Vcc, a decreased power supply voltage Vdd particularly used for the power supply of driver circuit 40. Circuit 42 for example comprises a voltage divider.

According to an embodiment, timing signal Comᵢ, received at a conductive pad P_Row of each display pixel 12_{i,j}, is a binary signal alternating between a low logical state “0” and a high logical state “1”, the low logical state corresponding to low reference potential Gnd and the high logical state “1” corresponding to power supply voltage Vdd. Data signal Dataⱼ, received at a conductive pad P_Col of each display pixel 12_{i,j}, is a binary signal alternating between a low logical state “0” and a high logical state “1”, the low logical state corresponding to low reference potential Gnd and the high logical state “1” corresponding to power supply voltage Vdd.

Driver circuit 40 comprises a circuit 46 (Mode selection) coupled to conductive pad P_Col receiving data signal Dataⱼ and coupled to conductive pad P_Row receiving timing signal Comᵢ and configured to deliver a clock signal Clk from timing signal Comᵢ and a data signal Data from data signal Dataⱼ to a storage circuit 48 (Color Data registers) or to deliver a modulation timing signal PWM from timing signal Comᵢ to a circuit 50 (LED driver) for controlling the controllable current source CS associated with each light-emitting diode LED.

Storage circuit 48 is clocked by clock signal Clk and is configured to store digital color signals R, G, B based on received digital data Data. Digital color signals R, G, B comprise each a number NB of bits and are representative of the image pixel color components to be displayed. Circuit 50 (LED driver) is configured to control the controllable current sources CS coupled to light-emitting diodes LED with signals I_red, I_green, and I_blue, obtained from digital color signals R, G, B, and from modulation timing signal PWM.

FIG. 4 shows a timing diagram of timing signal Comᵢ and data signal Dataⱼ sent to a display pixel 12_{i,j} according to an embodiment of a method for controlling the display pixel 12_{i,j}. Black areas correspond to time periods where timing signal Comᵢ/data signal Dataⱼ alternates between logical states “0” and “1”.

The display of a new image pixel by a display pixel 12_{i,j}, with i varying from 1 to M and j varying from 1 to N, comprises a first phase P1 followed by a second phase P2. During first phase P1, also called programming phase, display pixel 12_{i,j} is selected and data signal Dataⱼ is transmitted to selected display pixel 12_{i,j}. Digital color signals R, G, B are stored by selected display pixel 12_{i,j} based on received data signals Dataⱼ. During second phase P2, also called display phase, the light-emitting diodes of display pixel 12_{i,j} are controlled from digital color signals R, G, B, to display the image pixel. Display phase P2 is followed by the programming phase P1 for a new image pixel.

According to an embodiment, the selection of a display pixel 12_{i,j} in phase P1 is initiated by providing simultaneously a first pattern of timing signal Comᵢ and a second pattern of data signal Dataⱼ and is ended by providing simultaneously a third pattern of timing signal Comᵢ and a fourth pattern of data signal Dataⱼ. According to an embodiment, the first pattern of timing signal Comᵢ for initiating phase P1 is identical to the third pattern of timing signal Comᵢ for ending phase P1 and the second pattern of data signal Dataⱼ for initiating phase P1 is different from the fourth pattern of data signal Dataⱼ for ending phase P1. During phase P1, timing signal Comᵢ does not present the first pattern simultaneously with data signal Dataⱼ presenting the second pattern. According to an embodiment, the driving of the light-emitting diodes LED in phase P2 starts as soon as phase P1 ends.

According to an embodiment, the signals used by the display pixel 12_{i,j} during phase P1 for storing any digital color signals R, G, B in the storage circuit 48, and during phase P2 also for driving the light-emitting diodes LED do not need to present simultaneously the first and second patterns nor simultaneously the third and fourth patterns. Therefore, the simultaneous combination of first and second patterns or the simultaneous combination of third and fourth patterns can be prevented from happening inadvertently during the programming phase P1 and/or during the display phase P2, but is only specifically sent on purpose to initiate/end the programming phase P1 and/or the display phase P2.

According to an embodiment, light-emitting diodes LED of display pixel 12_{i,j} are controlled by pulse-width modulation in phase P2. For this purpose, during a display phase P2, timing signal Comᵢ exhibits a succession of pulses, for example at logical state “0”, which rates the operation of circuit 50 for the control of light-emitting diodes LED by pulse-width modulation. The number of pulses in the succession of pulses corresponds to the number NB of bits of each digital color signal R, G, and B. As an example, when current source CS corresponds to a MOS transistor, this transistor is turned on or is turned off, at the rate of the pulses of timing signal Comᵢ, according to the logical value “0” or “1” of each bit of color signal R, G, or B, from the most significant bit to the least significant bit, this transistor being maintained on or off until the next pulse of timing signal Comᵢ. The duration between two successive pulses of timing signal Comᵢ is divided each time by two, so that the total duration for which the light-emitting diode is on depends on the value of color signal R, G, or B. As a variation, the transistor is turned on or is turned off, at the rate of the pulses of timing signal Comᵢ, according to the logical value “0” or “1” of each bit of color signal R, G, or B, from the least significant bit to the most significant bit, the transistor being maintained on or off until the next pulse of timing signal Comᵢ. The duration between two successive pulses of timing signal Comᵢ is then multiplied each time by two, so that the total duration for which the light-emitting diode is on depends on the value of color signal R, G, or B. In FIG. 4, a new writing phase P1 follows the pulse of timing signal Comᵢ of the preceding display phase P2 corresponding to the least significant bit of color signal R, G, or B. According to another embodiment, the succession of pulses of signal timing signal Comᵢ can be repeated until the display of another image pixel. In that case, the succession of pulses of signal timing signal Comᵢ forms a display cycle and display phase P2 comprises more than one display cycle. According to an embodiment, data signal Dataⱼ remains at a constant logical state, for example at logical state “0”, during each pulse of timing signal Comᵢ used for the pulse-width modulation during phase P2.

According to an embodiment, clock signal Clk is equal to timing signal Comᵢ during phase P1 and signal Data is equal to data signal Dataⱼ during phase P1. Bits are stored in storage circuit 48 clocked by clock signal Clk. This means that clock signal Clk triggers the storage of the bits of signal Data in storage circuit 48. As an example, when storage circuit 48 comprises several memory cells, the updates of bits stored in the memory cells are triggered by clock signal Clk. In particular, during phase P1, an update storage circuit 48 can be performed only at each rising edge of timing signal Comᵢ, or only at each falling edge of timing signal Comᵢ, or at each rising edge and each falling edge of timing signal Comᵢ. The bit that is stored in a memory cell of storage circuit 48 can be equal to the logical level of signal Data at the moment of the update.

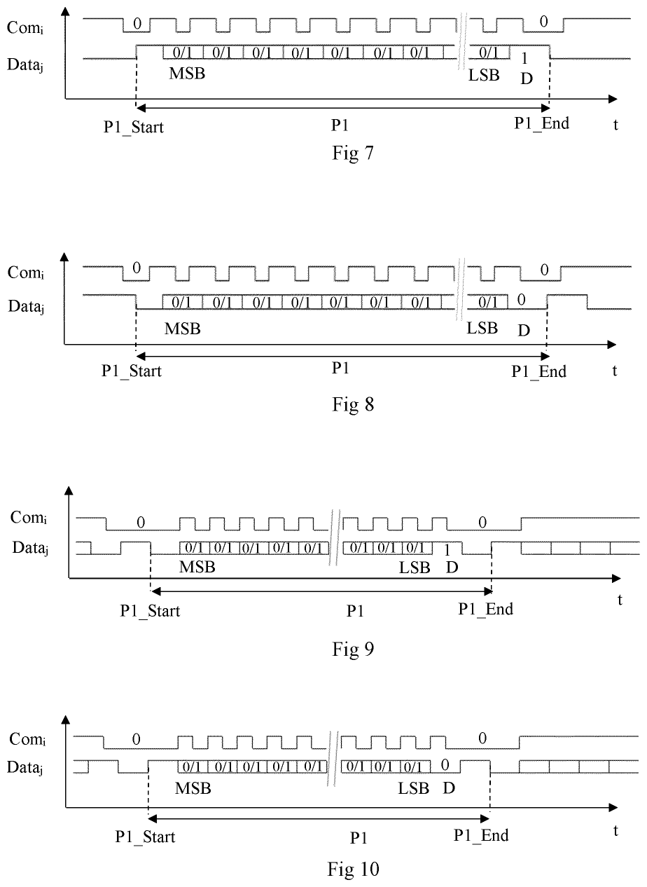

FIG. 5, FIG. 6, FIG. 7, FIG. 8, FIG. 9, and FIG. 10 show timing diagrams of timing signal Comᵢ and data signal Dataⱼ sent to a display pixel 12_{i,j} according to embodiments of a method for selecting the display pixel. In these Figures, programming phase P1 begins at instant P1_Start and ends at instant P1_End. During phase P1, bits are stored in storage circuit 48 of display pixel 12_{i,j}. During phase P1, circuit 46 sends clock signal Clk to storage circuit 48. Clock signal Clk is equal to timing signal Comᵢ during phase P1 and signal Data is equal to data signal Dataⱼ during phase P1. The successive bits of data signal Dataⱼ sent to storage circuit 48 are indicated in FIG. 5 to FIG. 10 by reference “0/1”. According to an embodiment, bits are sent to storage circuit 48 from the most significant bit MSB to the least significant bit LSB of color digital signals R, G, B to be stored in storage circuit 48. During phase P1, some bits D of signal Dataⱼ may not correspond to bits of digital signals R, G, B. It can be the case for the first bit of signal Dataⱼ sent to storage circuit 48 after instant P1_Start or/and for the last bit of signal Dataⱼ sent to storage circuit 48 before instant P1_End.

According to the embodiment shown in FIG. 5, the first pattern corresponds to signal Comᵢ remaining at logical state “0”, the second pattern corresponds to signal Dataⱼ having two successive rising edges, the third pattern is identical to the first pattern and the fourth pattern is the logical complement of the second pattern. Therefore, selection of a display pixel 12_{i,j} of display screen 10 is initiated when circuit 46 detects the second rising edge, at instant P1_Start, of two successive rising edges of data signal Dataⱼ while timing signal Comᵢ remains at logical level “0” and selection of a display pixel 12_{i,j} of display screen 10 is ended when circuit 46 detects the second falling edge, at instant P1_End, of two successive falling edges of data signal Dataⱼ while timing signal Comᵢ remains at logical level “0”. According to an embodiment, during phase P1, a bit is stored in storage circuit 48 at each rising edge and each falling edge of timing signal Comᵢ, the stored bit being equal to the logical level of signal Data at the rising edge/falling edge of timing signal Comᵢ.

According to the embodiment shown in FIG. 6, the first pattern corresponds to signal Comᵢ remaining at logical state “0”, the second pattern corresponds to signal Dataⱼ having two successive falling edges, the third pattern is identical to the first pattern and the fourth pattern is the logical complement of the second pattern. Therefore, selection of a display pixel 12_{i,j} of display screen 10 is initiated when circuit 46 detects the second falling edge, at instant P1_Start, of two successive falling edges of data signal Dataⱼ while timing signal Comᵢ remains at logical level “0” and selection of a display pixel 12_{i,j} of display screen 10 is ended when circuit 46 detects the second rising edge, at instant P1_End, of two successive falling edges of data signal Dataⱼ while timing signal Comᵢ remains at logical level “0”. According to an embodiment, during phase P1, a bit is stored in storage circuit 48 at each rising edge and each falling edge of timing signal Comᵢ, the stored bit being equal to the logical level of signal Data at the rising edge/falling edge of timing signal Comᵢ.

According to the embodiment shown in FIG. 7, the first pattern corresponds to signal Comᵢ remaining at logical state “0”, the second pattern corresponds to signal Dataⱼ having one rising edge, the third pattern is identical to the first pattern and the fourth pattern is the logical complement of the second pattern. Therefore, selection of a display pixel 12_{i,j} of display screen 10 is initiated when circuit 46 detects, at instant P1_Start, one rising edge of data signal Dataⱼ while timing signal Comᵢ is at logical level “0” and selection of a display pixel 12_{i,j} of display screen 10 is ended when circuit 46 detects, at instant P1_End, one falling edge of data signal Dataⱼ while timing signal Comᵢ is at logical level “0”. According to an embodiment, during phase P1, a bit is stored in storage circuit 48 only at each falling edge of timing signal Comᵢ, the stored bit being equal to the logical level of signal Data at the falling edge of timing signal Comᵢ.

According to the embodiment shown in FIG. 8, the first pattern corresponds to signal Comᵢ remaining at logical state “0”, the second pattern corresponds to signal Dataⱼ having one falling edge, the third pattern is identical to the first pattern and the fourth pattern is the logical complement of the second pattern. Therefore, selection of a display pixel 12_{i,j} of display screen 10 is initiated when circuit 46 detects, at instant P1_Start, one falling edge of data signal Dataⱼ while timing signal Comᵢ is at logical level “0” and selection of a display pixel 12_{i,j} of display screen 10 is ended when circuit 46 detects, at instant P1_End, one rising edge of data signal Dataⱼ while timing signal Comᵢ is at logical level “0”. According to an embodiment, during phase P1, a bit is stored in storage circuit 48 only at each falling edge of timing signal Comᵢ, the stored bit being equal to the logical level of signal Data at the falling edge of timing signal Comᵢ.

According to the embodiment shown in FIG. 9, the first pattern corresponds to signal Comᵢ remaining at logical state “0”, the second pattern corresponds to signal Dataⱼ having successively a rising edge and a falling edge, the third pattern is identical to the first pattern and the fourth pattern is the logical complement of the second pattern. Therefore, selection of a display pixel 12_{i,j} of display screen 10 is initiated when circuit 46 detects, at instant P1_Start, a falling edge of data signal Dataⱼ that follows a rising edge of data signal Dataⱼ while timing signal Comᵢ is at logical level “0” and selection of a display pixel 12_{i,j} of display screen 10 is ended when circuit 46 detects, at instant P1_End, a rising edge of data signal Dataⱼ that follows a falling edge of data signal Dataⱼ while timing signal Comᵢ is at logical level “0”. According to an embodiment, during phase P1, a bit is stored in storage circuit 48 only at each falling edge of timing signal Comᵢ, the stored bit being equal to the logical level of signal Data at the falling edge of timing signal Comᵢ.

According to the embodiment shown in FIG. 10, the first pattern corresponds to signal Comᵢ remaining at logical state “0”, the second pattern corresponds to signal Dataⱼ having successively a falling edge and a rising edge, the third pattern is identical to the first pattern and the fourth pattern is the logical complement of the second pattern. Therefore, selection of a display pixel 12_{i,j} of display screen 10 is initiated when circuit 46 detects, at instant P1_Start, a rising edge of data signal Dataⱼ that follows a falling edge of data signal Dataⱼ while timing signal Comᵢ is at logical level “0” and selection of a display pixel 12_{i,j} of display screen 10 is ended when circuit 46 detects, at instant P1_End, a falling edge of data signal Dataⱼ that follows a rising edge of data signal Dataⱼ while timing signal Comᵢ is at logical level “0”. According to an embodiment, during phase P1, a bit is stored in storage circuit 48 only at each falling edge of timing signal Comᵢ, the stored bit being equal to the logical level of signal Data at the falling edge of timing signal Comᵢ.

The selection of a display pixel 12_{i,j} based of a specific pattern of timing signal Comᵢ and data signal Dataⱼ allows partial updating of the displayed image.

FIG. 11 shows schematically an image Im displayed on a display screen for which only a part Im5 needs to be updated, the rest of image Im remaining unchanged. The image Im can be divided in nine parts. Part Im5 corresponds to display pixels located at rows that receive the selection pattern of timing signal Comᵢ and located at columns that receive the selection pattern of data signal Dataⱼ. Each part Im1, Im3, Im7, and Im9 corresponds to display pixels located at rows that do not receive the selection pattern of timing signal Comᵢ and located at columns that do not receive the selection pattern of data signal Dataⱼ. Each part Im2 and Im8 corresponds to display pixels located at rows that do not receive the selection pattern of timing signal Comᵢ and located at columns that receive the selection pattern of data signal Dataⱼ. Each part Im4 and Im6 corresponds to display pixels located at rows that receive the selection pattern of timing signal Comᵢ and located at columns that do not receive the selection pattern of data signal Dataⱼ.

In FIG. 11 are also shown a timing signal Com₁₋₂₋₃ sent to the display pixels at one row crossing parts Im1, Im2, and Im3 of image Im, a timing signal Com₄₋₅₋₆ sent to the display pixels at one row crossing parts Im4, Im5, and Im6 of image Im, a timing signal Com₇₋₈₋₉ sent to the display pixels at one row crossing parts Im7, Im8, and Im9 of image Im, a data signal Data₁₋₄₋₇ sent to the display pixels at one column crossing parts Im1, Im4, and Im7 of image Im, a data signal Data₂₋₅₋₈ sent to the display pixels at one column crossing parts Im2, Im5, and Im8 of image Im, and a data signal Data₃₋₆₋₉ sent to the display pixels at one column crossing parts Im3, Im6, and Im9 of image Im.

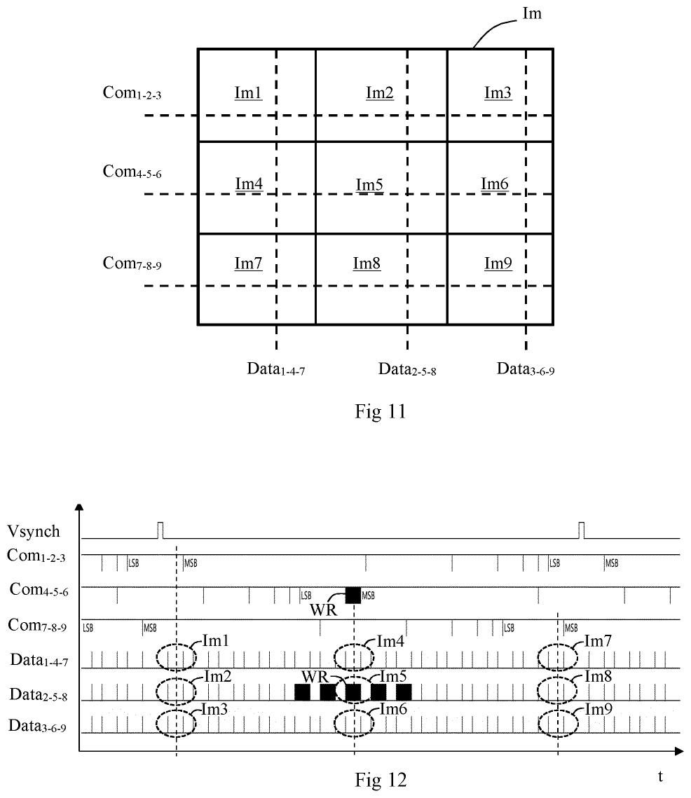

FIG. 12 shows a timing diagram of signals Com₁₋₂₋₃, Com₄₋₅₋₆, Com₇₋₈₋₉, Data₁₋₄₋₇, Data₂₋₅₋₈, and Data₃₋₆₋₉ according to the embodiment of method for selecting display pixels illustrated in FIGS. 7 and 8. Signal Vsynch is a binary signal having a pulse at the beginning of the display of an updated image. Black areas WR correspond to time periods where timing signal and data signal alternates between logical states “0” and “1” and start with a selection pattern. In FIG. 12, references Im1, Im2, Im3, Im4, Im5, Im6, Im7, Im8, and Im9 indicates to which parts of image Im of FIG. 11 are associated the display pixels receiving data signal Data₁₋₄₋₇, Data₂₋₅₋₈, and Data₃₋₆₋₉. Only the display pixels associated to part Im5 receive a selection pattern for the timing signal (signal Com₄₋₅₋₆) and a selection pattern for the data signal (signal Data₂₋₅₋₈), and are therefore selected for a storage of updated digital color signals. The display pixels associated to parts Im1, Im3, Im7, and Im9 of image Im do not receive a selection pattern for the timing signal (signals Com₁₋₂₋₃ and Com₇₋₈₋₉) and do not receive a selection pattern for the data signal (signals Data₁₋₄₋₇ and Data₃₋₆₋₉) and are therefore not selected for a storage of updated digital color signals. The display pixels associated to parts Im2 and Im8 of image Im do not receive a selection pattern for the timing signal (signals Com₁₋₂₋₃ and Com₇₋₈₋₉) but receive a selection pattern for the data signal (signal Data₂₋₅₋₈) and are therefore not selected for a storage of updated digital color signals. The display pixels associated to parts Im4 and Im6 of image Im receive a selection pattern for the timing signal (signal Com₄₋₅₋₆) but do not receive a selection pattern for the data signal (signals Data₁₋₄₋₇ and Data₃₋₆₋₉) and are therefore not selected for a storage of updated digital color signals.

According to an embodiment, circuit 46 comprises a finite-state machine.

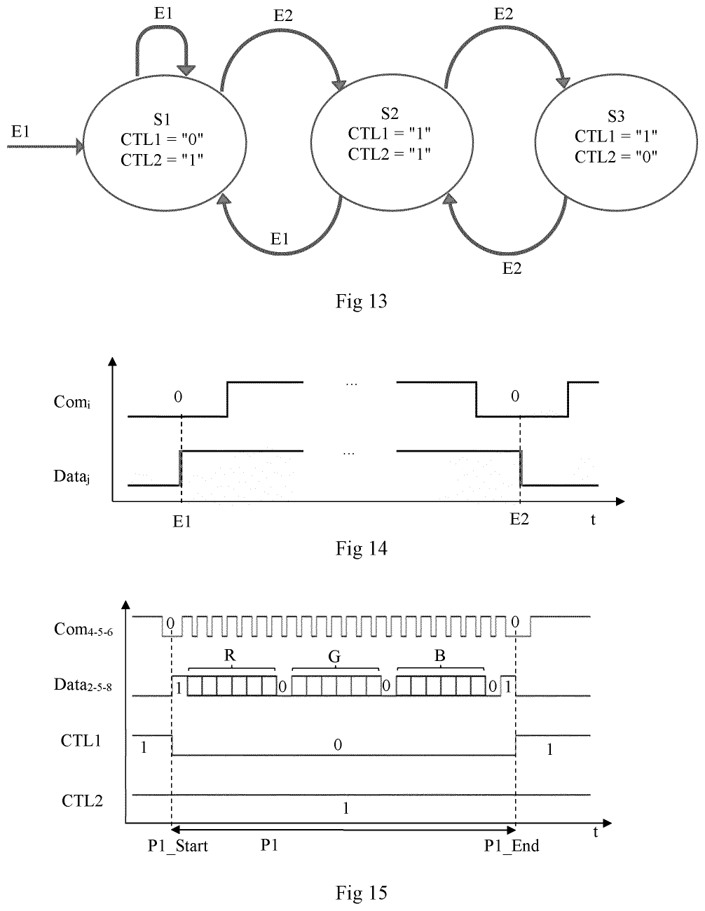

FIG. 13 is a state diagram of an embodiment of the finite-state machine of circuit 50 adapted to implement the selection method illustrated in FIGS. 7 and 8. Finite-state machine comprises three states S1, S2, and S3. In state S1, display pixel 12_{i,j} is selected and performs a writing operation. This means that circuit 46 transmits to circuit 48 the bits of digital signal Data clocked by clock signal Clk. In state S2, display pixel 12_{i,j} is not selected and performs a display operation. This means that circuit 50 commands the switching on/off of the light emitting diodes using signal PWM that is equal to timing signal Comᵢ and that is adapted to perform a pulse-width modulation. In state S3, display pixel 12_{i,j} is not selected and does not perform a display operation. In this state, signal PWM is set to “0” independently of signal timing signal Comᵢ. State S3 is used when display pixel 12_{i,j} is not to be selected but receives a timing signal Comᵢ that is adapted to a writing operation and therefore cannot be used to generate signal PWM adapted to perform a pulse-width modulation.

The entry action in state S1 occurs when event E1 is detected. When in state S1, a transition from state S1 to state S2 occurs when event E2 is detected. When in state S1, the finite-state machine remains in state S1 when event E1 is detected. When in state S2, a transition from state S2 to state S1 occurs when event E1 is detected. When in state S2, a transition from state S2 to state S3 occurs when event E2 is detected. When in state S3, a transition from state S3 to state S2 occurs when event E2 is detected. States can be defined by the logical states of two bits CTL1 and CTL2 generated inside the display pixel. As an example, bit CTL1 is set to logical state “0” and bit CTL2 is set to logical state “1” in state S1. Bit CTL1 is set to logical state “1” and bit CTL2 is set to logical state “1” in state S2. Bit CTL1 is set to logical state “1” and bit CTL2 is set to logical state “0” in state S3. Event E1 corresponds to the start of a programming phase P1, and event E2 corresponds to the end of a programming phase P1.

FIG. 14 illustrates events E1 and E2 triggering transitions in the state diagram of FIG. 13 corresponding to the embodiment shown in FIG. 7. Event E1 is detected by display pixel 12_{i,j} when there is a rising edge of data signal Dataⱼ while timing signal Comᵢ is at logical state “0”. Event E2 is detected by display pixel 12_{i,j} when there is a falling edge of data signal Dataⱼ while timing signal Comᵢ is at logical state “0”.

FIG. 15, FIG. 16, and FIG. 17 show timing diagrams of signals provided to the display pixels for displaying image Im of FIG. 11 and signals generated inside the display pixels according to the embodiment with the state diagram of FIG. 12 and the events E1 and E2 shown in FIG. 14.

FIG. 15 shows a timing diagram of signals Com₄₋₅₋₆ and Data₂₋₅₋₈ received by a display pixel for displaying an image pixel of part Im5 of image Im, and bits CTL1 and CTL2 calculated by the display pixel. At instant P1_Start, event E1 is detected so that bit CTL1, which was equal to logical state “1”, is set to logical state “0” and bit CTL2 remains in logical state “1”. Therefore, the finite-state machine goes from state S2 to state S1. In state S1, the writing of updated digital color signals R, G, and B is implemented. As an example, signal Data₂₋₅₋₈ comprises successively the bits of digital color signal R, a bit at logical state “0”, the bits of color signal G, a bit at logical state “0”, and the bits of color signal B. At instant P1_End, event E2 is detected so that bit CTL1 is set to logical state “1” and bit CTL2 remains in logical state “1”. Therefore, the finite-state machine goes to state S2.

FIG. 16 shows a timing diagram of signal Com₄₋₅₋₆, signal Data₁₋₄₋₇/Data₃₋₆₋₉ received by a display pixel for displaying an image pixel of part Im4 or Im6 of image Im, and bits CTL1 and CTL2 calculated by the display pixel. Data delivery circuit 24 provides signal Data₁₋₄₋₇/Data₃₋₆₋₉ having pulses so that, at instant E2_S, event E2 is detected so that bit CTL1 remains to logical state “1” and bit CTL2, which was equal to logical state “1”, is set to logical state “0”. Therefore, the finite-state machine goes from state S2 to state S3. In this state, signal PWM is set to “0” independently of signal timing signal Com₄₋₅₋₆. At instant E2_E, event E2 is detected so that bit CTL1 remains to logical state “1” and bit CTL2 is set to logical state “1”. Therefore, the finite-state machine goes to state S2 and signal PWM is equal to signal timing signal Com₄₋₅₋₆.

FIG. 17 shows a timing diagram of signal Com₁₋₄₋₇/Com₃₋₆₋₉ and signal Data₁₋₄₋₇/Data₃₋₆₋₉ received by a display pixel for displaying an image pixel of part Im1 or Im2 or Im3 or Im7 or Im8 or Im9 of image Im, and bits CTL1 and CTL2 calculated by the display pixel. No event is detected so that bit CTL1 remains to logical state “1” and bit CTL2 remains to logical state “1”. Therefore, the finite-state machine remains in state S2.

The embodiment disclosed previously in relation to FIG. 8 can be implemented by using the finite-state machine having the state diagram of FIG. 13 in which events E1 and E2 are permuted.

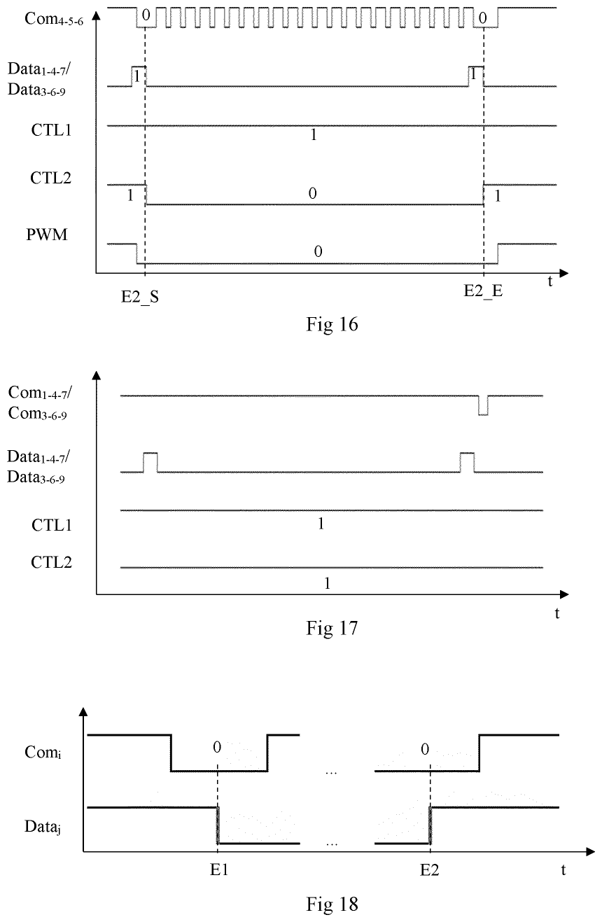

FIG. 18 illustrates events E1 and E2 triggering transitions in the state diagram of FIG. 13 corresponding to the embodiment shown in FIG. 8. Event E1 is detected by display pixel 12_{i,j} when there is a falling edge of data signal Dataⱼ while timing signal Comᵢ is at logical state “0”. Event E2 is detected by display pixel 12_{i,j} when there is a rising edge of data signal Dataⱼ while timing signal Comᵢ is at logical state “0”.

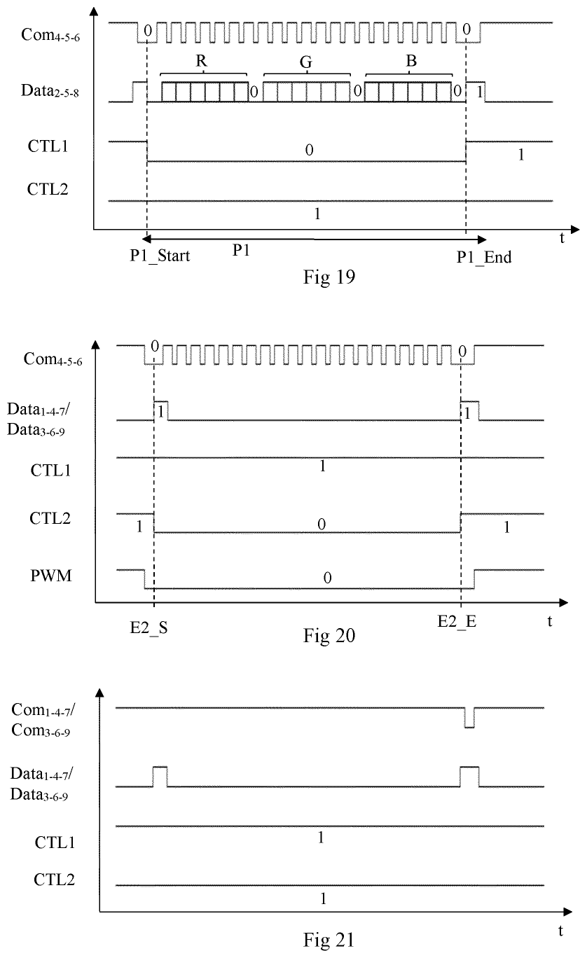

FIG. 19, FIG. 20, and FIG. 21 show timing diagrams of signals provided to display pixels for displaying image Im of FIG. 11 and signals generated inside the display pixels according to the embodiment with the state diagram of FIG. 13 and the events shown in FIG. 18.

FIG. 19 shows a timing diagram of signals Com₄₋₅₋₆ and Data₂₋₅₋₈ received by a display pixel for displaying an image pixel of part Im5 of image Im, and bits CTL1 and CTL2 calculated by the display pixel. At instant P1_Start, event E1 is detected so that bit CTL1, which was equal to logical state “1”, is set to logical state “0” and bit CTL2 remains in logical state “1”. Therefore, the finite-state machine goes from state S2 to state S1. In state S1, the writing of updated digital color signals R, G, and B is implemented. As an example, signal Data₂₋₅₋₈ comprises successively the bits of digital color signal R, a bit at logical state “0”, the bits of color signal G, a bit at logical state “0”, and the bits of color signal B. At instant P1_End, event E2 is detected so that bit CTL1 is set to logical state “1” and bit CTL2 remains in logical state “1”. Therefore, the finite-state machine goes to state S2.

FIG. 20 shows a timing diagram of signal Com₄₋₅₋₆, signal Data₁₋₄₋₇/Data₃₋₆₋₉ received by a display pixel for displaying an image pixel of part Im4 or Im6 of image Im, and bits CTL1 and CTL2 calculated by the display pixel. Data delivery circuit 24 provides signal Data₁₋₄₋₇/Data₃₋₆₋₉ having pulses so that, at instant E2_S, event E2 is detected so that bit CTL1 remains to logical state “1” and bit CTL2, which was equal to logical state “1”, is set to logical state “0”. Therefore, the finite-state machine goes from state S2 to state S3. In this state, signal PWM is set to “0” independently of timing signal Com₄₋₅₋₆. At instant E2_E, event E2 is detected so that bit CTL1 remains to logical state “1” and bit CTL2 is set to logical state “1”. Therefore, the finite-state machine goes to state S2 and signal PWM is equal to signal timing signal Com₄₋₅₋₆.

FIG. 21 shows a timing diagram of signal Com₁₋₄₋₇/Com₃₋₆₋₉ and signal Data₁₋₄₋₇/Data₃₋₆₋₉ received by a display pixel for displaying an image pixel of part Im1 or Im2 or Im3 or Im7 or Im8 or Im9 of image Im, and bits CTL1 and CTL2 calculated by the display pixel. No event is detected so that bit CTL1 remains to logical state “1” and bit CTL2 remains to logical state “1”. Therefore, the finite-state machine remains in state S2.

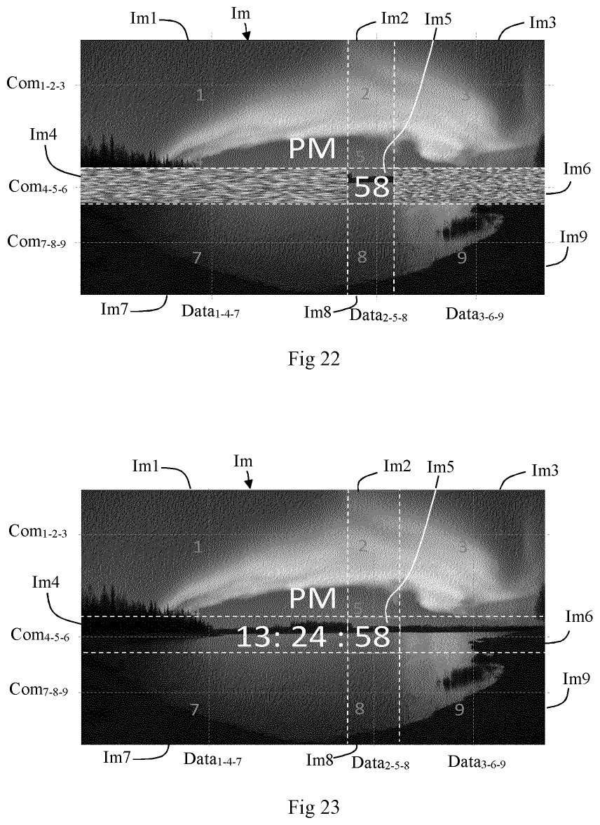

FIG. 22 shows an image Im displayed on a display screen for which only portion Im5 of the image is updated while implementing a known method for displaying the image. As seen in FIG. 22, portions Im4 and Im6 of image Im are also updated with portion Im5. This leads to portions Im4 and Im6 displaying random pixels in case data signal Dataⱼ provided to display pixels associated with portions Im4 and Im6 are not also updated.

FIG. 23 shows the image Im displayed on a display screen for which only portion Im5 of the image is updated while implementing the method for displaying the image according to the embodiment disclosed in relation to FIGS. 13 and 14.

According to an embodiment of the display screen 10 shown in FIG. 1, for each row, the display pixels 12_{i,j} in the row are coupled to a single row electrode 18ᵢ. For each column, the display pixels 12_{i,j} in the column are coupled to a single column electrode 20j. Display screen 10 comprises a timing circuit 22 coupled to row electrodes 18ᵢ and adapted to delivering a timing signal Comᵢ on each row electrode 18ᵢ. Display screen 10 comprises a data delivery circuit 24 coupled to column electrodes 20 and adapted to delivering a data signal Dataⱼ on each column electrode 20j. Timing circuit 22 and electrically circuit 24 are controlled by a circuit 26, for example comprising a microprocessor.

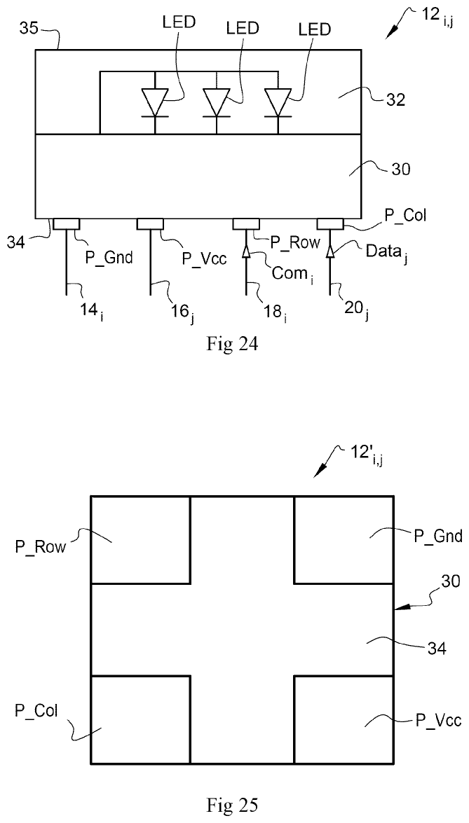

FIG. 24 is a very simplified cross-section view of a known example of display pixel 12_{i,j} and FIG. 25 is a bottom view of display pixel 12_{i,j}. Each display pixel 12_{i,j} comprises a control circuit 30 covered with a display circuit 32. Display circuit 32 comprises at least one light-emitting diode LED, preferably at least three light-emitting diodes LED. The display pixel comprises a lower surface 34 and an upper surface 35 opposite to lower surface 34, surfaces 34 and 35 being preferably planar and parallel. Control circuit 30 further comprises conductive pads P_Gnd, P_Vcc, P_Col, P_Row on lower surface 34. Control circuit 30 may correspond to an integrated circuit comprising electronic components, particularly insulated gate field effect transistors, also called MOS transistors, or thin film transistors, also called TFTs. Preferably, display circuit 32 only comprises light-emitting diodes LED and the conductive elements of these light-emitting diodes LED, and control circuit 30 comprises all the electronic components necessary to the control of the light-emitting diodes LED of display circuit 32. As a variant, display circuit 32 may also comprise other electronic components in addition to light-emitting diodes LED. Light-emitting diodes LED may be 2D light-emitting diodes, also called planar light-emitting diodes, comprising a stack of planar layers, or 3D light-emitting diodes, each comprising a three-dimensional semiconductor element covered with an active area. In FIG. 24, the light-emitting diodes are shown as being connected with a common anode. It may however be desirable to arrange light-emitting diodes LED according to another configuration. As an example, the light-emitting diodes may be connected with a common cathode, or be connected independently from one another.

According to an embodiment, display pixel 12_{i,j} comprises three display sub-pixels emitting light at first, second, and third wavelengths. According to an embodiment, the first wavelength corresponds to blue light and is within the range from 430 nm to 490 nm. According to an embodiment, the second wavelength corresponds to green light and is within the range from 510 nm to 570 nm. According to an embodiment, the third wavelength corresponds to red light and is within the range from 600 nm to 720 nm. As a variation, the display pixel 12_{i,j} can comprise only one light source emitting light at the first, second, or third wavelength, or only two light sources emitting light at two wavelengths among the first, second, and third wavelengths.

Each conductive pad P_Gnd, P_Vcc, P_Col, P_Row is intended to be connected to one of electrodes 14ᵢ, 16j, 18ᵢ, 20 schematically shown in FIG. 24. The first conductive pad P_Gnd is coupled to the source of low reference potential Gnd. The second conductive pad P_Vcc is coupled to the source of high reference potential Vcc. The third conductive pad P_Row is coupled to row electrode 18ᵢ and receives timing signal Comᵢ. The fourth conductive pad P_Col is coupled to column electrode 20 and receives data signal Dataⱼ. The dimensions of conductive pads P_Gnd, P_Vcc, P_Col, P_Row and the layout of conductive pads P_Gnd, P_Vcc, P_Col, P_Row on surface 34 are particularly imposed by the rules of design of display pixel 12_{i,j} and by the method of assembly of display pixels 12_{i,j} in display screen 10.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

1. A display pixel comprising at least one light-emitting source and an electronic circuit comprising a storage circuit for storing at least one digital signal and a driver circuit for driving said light-emitting source based on the stored digital signal, said display pixel comprising at least a first electrically conductive pad intended to receive a first binary signal and a second electrically conductive pad intended to receive a second binary signal, each of the first binary signal and the second binary signal alternating between a low logical state and a high logical state, the low logical state corresponding to a low reference potential and the high logical state corresponding to a power supply voltage, the first and second electrically conductive pads being connected to said electronic circuit, said electronic circuit being configured to update said stored digital signal from the second binary signal after the detection of a first pattern of the first binary signal simultaneously with a second pattern of the second binary signal.

2. The display pixel of claim 1, wherein said electronic circuit is configured not to update said stored digital signal from the second binary signal when the first pattern of the first binary signal is not detected simultaneously with the second pattern of the second binary signal.

3. The display pixel of claim 1, wherein said electronic circuit is configured to end the update of said stored digital signal from the second binary signal after the detection of a third pattern of the first binary signal simultaneously with a fourth pattern of the second binary signal.

4. The display pixel of claim 3, wherein the third pattern is identical to the first pattern and wherein the fourth pattern is different from the second pattern.

5. The display pixel of claim 4, wherein the fourth pattern is the logical complement of the second pattern.

6. The display pixel of claim 1, wherein the first pattern corresponds to the first binary signal remaining at a given logical state.

7. The display pixel of claim 1, wherein the second pattern corresponds to the second binary signal comprising one rising edge, or two successive rising edges, or one falling edge, or two successive falling edges, or one rising edge followed by one falling edge, or one falling edge followed by one rising edge.

8. The display pixel of claim 1, wherein, after the detection of the first pattern of the first binary signal simultaneously with the second pattern of the second binary signal, the electronic circuit is configured to update the digital signal in the storage circuit clocked by a clock signal equal to the first binary signal.

9. The display pixel of claim 8, wherein the electronic circuit is configured to update successive bits of the digital signal in the storage circuit equal to the successive logical states of the second binary signal at only the rising edges, or at only the falling edges, or at the rising and falling edges of the clock signal.

10. The display pixel of claim 8, wherein the driver circuit is configured to drive said light-emitting source by pulse-width modulation based of the digital signal and pulses of the first binary signal.

11. The display pixel of claim 3, wherein said electronic circuit is configured to perform the update of said stored digital signal without needing the simultaneous reception of the first and second patterns and without needing the simultaneous reception of the third and fourth patterns and said driver circuit is configured to perform the driving of said light-emitting source without needing the simultaneous reception of the first and second patterns and without needing the simultaneous reception of the third and fourth patterns.

12. The display pixel of claim 1, wherein the driver circuit comprises a finite-state machine comprising at least three states, the first state corresponding to the update of said digital signal, the second state corresponding to the driving of said light-emitting source and the third state corresponding to the switching off of said light-emitting source without update of the digital signal.

13. The display pixel of claim 12, wherein the transition of the finite-state machine from the second state to the first state corresponds to the detection by said electronic circuit of the first pattern of the first signal simultaneously with the second pattern of the second signal.

14. The display pixel of claim 13, wherein the transition of the finite-state machine from the first state to the second state corresponds to the detection by said electronic circuit of the third pattern of the first signal simultaneously with the fourth pattern of the second signal.

15. The display pixel of claim 12, wherein the transition of the finite-state machine from the second state to the third state corresponds to the detection by said electronic circuit of the third pattern of the first signal simultaneously with the fourth pattern of the second signal.

16. The display pixel of claim 12, wherein the transition of the finite-state machine from the third state to the second state corresponds to the detection by said electronic circuit of the third pattern of the first signal simultaneously with the fourth pattern of the second signal.

17. A display screen comprising:
display pixels according to claim 1 arranged in rows and in columns;
first electrically conductive tracks extending along the rows and connected to the electronic circuits of the display pixels;
a circuit for supplying the first signal comprising the first pattern successively on each first electrically conductive track;
second electrically conductive tracks extending along the columns and connected to the electronic circuits of the display pixels;
a circuit for supplying the second signals on the second electrically conductive tracks, at least some of the second signals comprising each the second pattern, so that each display pixel receiving simultaneously the first and second patterns performs an update of said stored digital signal.

18. The display screen of claim 17, wherein the circuit for supplying the first signal and the circuit for supplying the second signals are configured, after the supply of the first pattern on one of said first electrically conductive tracks, not to supply simultaneously the first pattern on said first electrically conductive track and the second pattern on the second electrically conductive tracks during the update performed by the display pixels connected to said first electrically conductive track.
